(19) United States
(12) Patent Application Publication
(10) Pub. No.: US 2025/0282197 A1
(43) Pub. Date: Sep. 11, 2025

(54) VEHICLE THERMAL MANAGEMENT SYSTEM

(71) Applicants: HYUNDAI MOTOR COMPANY, Seoul (KR); KIA CORPORATION, Seoul (KR)

(72) Inventors: Jong Won Kim, Cheonan-si (KR); Wan Je Cho, Hwaseong-si (KR)

(73) Assignees: HYUNDAI MOTOR COMPANY, Seoul (KR); KIA CORPORATION, Seoul (KR)

(21) Appl. No.: 18/743,800

(22) Filed: Jun. 14, 2024

(30) Foreign Application Priority Data
Mar. 5, 2024 (KR) 10-2024-0031502

(51) Int. Cl. B60H 1/00; B60H 1/32

(52) U.S. Cl. CPC B60H 1/00278; B60H 1/00885; B60H 1/3227; B60H 2001/00307; B60H 2001/00928

(57) ABSTRACT

A vehicle thermal management system includes a heating, ventilation, and air conditioning (HVAC) subsystem having a compressor, an accumulator disposed on an upstream side of the compressor, and a refrigerant circulation path fluidly connected to the accumulator. The thermal management system also includes a coolant subsystem having a coolant heater and a coolant circulation path fluidly connected to the coolant heater. The accumulator includes a refrigerant passage fluidly connected to the refrigerant circulation path and includes a coolant passage fluidly connected to the coolant circulation path.

### CROSS-REFERENCE TO RELATED APPLICATION

This application claims the benefit of priority to Korean Patent Application No. 10-2024-0031502, filed on Mar. 5, 2024 in the Korean Intellectual Property Office, the disclosure of which is incorporated herein in its entirety by reference.

### TECHNICAL FIELD

The present disclosure relates to a vehicle thermal management system, and more particularly, to a vehicle thermal management system configured to transfer heat between a coolant heater and an accumulator when an ambient temperature is relatively low.

### BACKGROUND

With a growing interest in energy efficiency and environmental issues, there is a demand for the development of eco-friendly vehicles that can replace internal combustion engine vehicles. Such eco-friendly vehicles are classified into electric vehicles which are driven using fuel cells or electricity as a power source and hybrid vehicles which are driven using an engine and a battery.

Electric vehicles or hybrid vehicles may include a vehicle thermal management system for heating, ventilation, and air conditioning (HVAC) in a cabin (or passenger compartment) and maintaining a battery and/or power electronics (PE) components of a PE system at appropriate temperatures. The vehicle thermal management system may include an HVAC subsystem for heating, ventilation, and air conditioning the cabin, and a coolant subsystem for maintaining the PE components and/or the battery at appropriate temperatures.

In the vehicle thermal management system according to the related art, when the HVAC subsystem operates in a heating mode to perform a cabin heating operation in a relatively low ambient temperature condition (e.g., −10° C. or below) such as in winter, an amount of heat absorbed by a refrigerant through an exterior heat exchanger, a battery chiller, and the like may be relatively insufficient. Accordingly, the HVAC subsystem may fail to smoothly operate in the heating mode. Thus, when the ambient temperature is relatively low, an electric heater such as a PTC heater may be used to heat the cabin, resulting in a significant waste of electric energy.

In addition, the coolant subsystem of the vehicle thermal management system may include a coolant heater, and the coolant heater may be designed to increase a temperature of the battery to a battery operating temperature when the temperature of the battery is lowered below the battery operating temperature. However, the coolant heater may only be used for battery warming-up, so the usability of the coolant heater may be reduced.

The above information described in this background section is provided to assist in understanding the background of the inventive concept. The above information may include any technical concept that is not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a vehicle thermal management system configured to transfer heat between a coolant heater and an accumulator when an ambient temperature is relatively low, thereby improving heating performance.

According to an aspect of the present disclosure, a vehicle thermal management system may include a heating, ventilation, and air conditioning (HVAC) subsystem having a compressor, an accumulator disposed on an upstream side of the compressor, and a refrigerant circulation path fluidly connected to the accumulator. The system may also include a coolant subsystem having a coolant heater and a coolant circulation path fluidly connected to the coolant heater. The accumulator may include a refrigerant passage fluidly connected to the refrigerant circulation path, and a coolant passage fluidly connected to the coolant circulation path.

The vehicle thermal management system may further include a battery chiller having a refrigerant passage fluidly connected to the refrigerant circulation path, and a coolant passage fluidly connected to the coolant circulation path.

The refrigerant passage of the battery chiller may be located on an upstream side of the refrigerant passage of the accumulator, and the coolant passage of the battery chiller may be located on a downstream side of the coolant passage of the accumulator.

The coolant heater may be located on an upstream side of the coolant passage of the accumulator.

The HVAC subsystem may further include an interior condenser disposed on a downstream side of the compressor, a refrigerant control valve disposed on a downstream side of the interior condenser, an exterior heat exchanger disposed on a downstream side of the refrigerant control valve, and a chiller-side expansion valve disposed on the upstream side of the refrigerant passage of the battery chiller. The chiller-side expansion valve may be configured to allow a refrigerant to flow from any one of the exterior heat exchanger and the interior condenser to the refrigerant passage of the battery chiller.

The refrigerant circulation path may include a heating-side bypass line extending from an upstream point of the refrigerant control valve to an upstream point of the refrigerant passage of the battery chiller.

The chiller-side expansion valve may include a first port fluidly communicating with the refrigerant passage of the battery chiller, a second port fluidly communicating with the exterior heat exchanger, and a third port fluidly communicating with the heating-side bypass line.

The chiller-side expansion valve may be configured to allow the first port to be fluidly connected to at least one of the second port and the third port by an actuator.

The coolant subsystem may further include a battery and a coolant control valve fluidly connected to the coolant circulation path. The coolant control valve may be configured to control the flow of a coolant passing through the battery, the coolant heater, the coolant passage of the accumulator, and the coolant passage of the battery chiller.

The coolant heater may be located on a downstream side of the battery.

The coolant subsystem may further include a battery bypass line extending from an upstream point of the battery to a downstream point of the battery.

The coolant subsystem may further include a distribution valve configured to allow the coolant discharged from the coolant control valve to be directed to at least one of the battery and the battery bypass line.

The distribution valve may include an inlet port fluidly communicating with the coolant control valve, a first outlet port fluidly communicating with the battery, and a second outlet port fluidly communicating with the battery bypass line.

### BRIEF DESCRIPTION OF THE DRAWINGS

The above and other objects, features, and advantages of the present disclosure should be more apparent from the following detailed description taken in conjunction with the accompanying drawings:

FIG. 1 illustrates a process of a vehicle thermal management system according to an embodiment of the present disclosure in which a refrigerant absorbs heat through an accumulator and a battery chiller; and

FIG. 2 illustrates a process of a vehicle thermal management system according to an embodiment of the present disclosure in which a refrigerant absorbs heat through an accumulator, a battery chiller, and an exterior heat exchanger.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure has been omitted in order not to unnecessarily obscure the gist of the present disclosure.

Terms such as first, second, A, B, (a), and (b) may be used to describe the elements in the embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those having ordinary skill in the art to which the present disclosure belongs. Such terms as those defined in a generally used dictionary are to be interpreted as having meanings consistent with the contextual meanings in the relevant field of art. Such terms are not to be interpreted as having ideal or excessively formal meanings unless clearly defined as having such in the present application.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

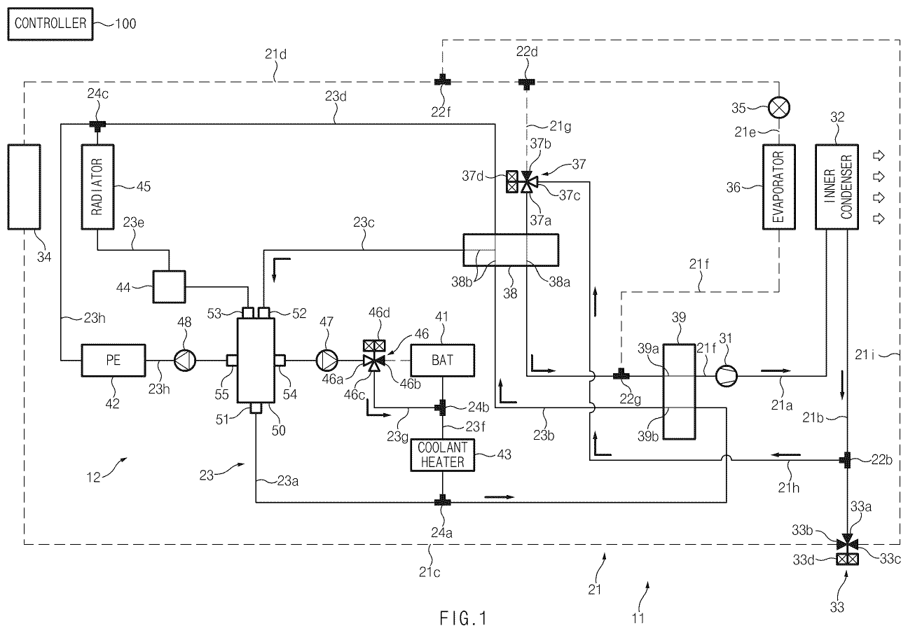

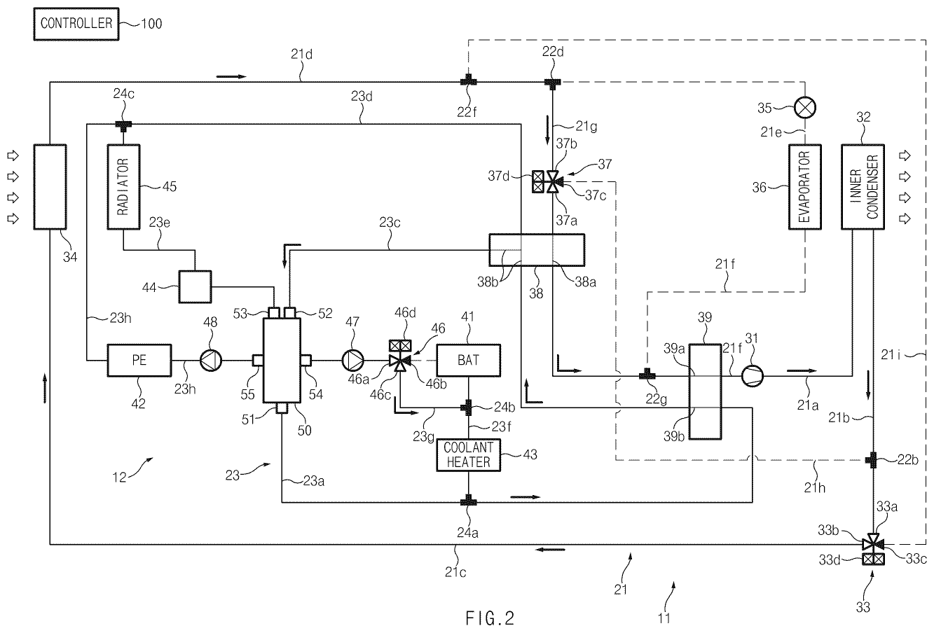

Referring to FIGS. 1 and 2, a vehicle thermal management system according to an embodiment of the present disclosure may include a heating, ventilation, and air conditioning (HVAC) subsystem 11 configured to heat or cool air in a cabin of a vehicle. The vehicle thermal management system may also include a coolant subsystem 12 configured to maintain a battery 41 and/or a power electronics (PE) component 42 at appropriate temperatures.

The HVAC subsystem 11 may include a refrigerant circulation path 21 through which a refrigerant circulates. The refrigerant circulation path 21 may be fluidly connected to a compressor 31, an interior condenser 32, a refrigerant control valve 33, an exterior heat exchanger 34, a cooling-side expansion valve 35, an evaporator 36, a chiller-side expansion valve 37, a battery chiller 38, and an accumulator 39.

Referring to FIG. 1, the refrigerant circulation path 21 may include: a first refrigerant line 21a extending from an outlet of the compressor 31 to the interior condenser 32; a second refrigerant line 21b extending from the interior condenser 32 to the refrigerant control valve 33; a third refrigerant line 21c extending from the refrigerant control valve 33 to an inlet of the exterior heat exchanger 34; a fourth refrigerant line 21d extending from an outlet of the exterior heat exchanger 34 to an inlet of the cooling-side expansion valve 35; a fifth refrigerant line 21e extending from an outlet of the cooling-side expansion valve 35 to an inlet of the evaporator 36; and a sixth refrigerant line 21f extending from an outlet of the evaporator 36 to an inlet of the compressor 31.

The refrigerant circulation path 21 may also include a distribution line 21g extending from a branch point 22d of the fourth refrigerant line 21d to a joint point 22g of the sixth refrigerant line 21f. An inlet of the distribution line 21g may be fluidly connected to the branch point 22d of the fourth refrigerant line 21d on the upstream side of the cooling-side expansion valve 35. An outlet of the distribution line 21g may be fluidly connected to the joint point 22g of the sixth refrigerant line 21f on the upstream side of the compressor 31.

The refrigerant circulation path 21 may include a heating-side bypass line 21h extending from a branch point 22b of the second refrigerant line 21b to one point of the distribution line 21g. The heating-side bypass line 21h may extend from an upstream point of the refrigerant control valve 33 to an upstream point of a refrigerant passage 38a of the battery chiller 38. An inlet of the heating-side bypass line 21h may be fluidly connected to the branch point 22b of the second refrigerant line 21b on the upstream side of the refrigerant control valve 33, and an outlet of the heating-side bypass line 21h may be fluidly connected to a third port 37c of the chiller-side expansion valve 37 on the upstream side of the refrigerant passage 38a of the battery chiller 38.

The refrigerant circulation path 21 may include a dehumidifying-side bypass line 21i extending from the refrigerant control valve 33 to a joint point 22f of the fourth refrigerant line 21d. An inlet of the dehumidifying-side bypass line 21i may be fluidly connected to a third port 33c of the refrigerant control valve 33. Furthermore, an outlet of the dehumidifying-side bypass line 21i may be fluidly connected to the joint point 22f of the fourth refrigerant line 21d on the upstream side of the cooling-side expansion valve 35.

The refrigerant circulation path 21 may allow the flow of the refrigerant to vary depending on an operating mode (a heating mode, a cooling mode, a dehumidifying mode, and the like) of the HVAC subsystem 11, a cooling mode and a warming-up mode of the battery 41, a cooling mode of the PE component 42, and the like.

The compressor 31 may compress the refrigerant. According to an embodiment, the compressor 31 may be an electric compressor driven by electric energy.

The interior condenser 32 may be configured to condense the refrigerant received from the compressor 31. In other words, the refrigerant compressed by the compressor 31 may transfer heat to the air and be condensed in the interior condenser 32. Accordingly, the interior condenser 32 may heat the air using the refrigerant compressed by the compressor 31, and the air heated by the interior condenser 32 may be directed into the cabin.

The refrigerant control valve 33 may be configured to control the flow of the refrigerant in a manner that allows the refrigerant discharged from the interior condenser 32 to be directed to at least one of the exterior heat exchanger 34 and the dehumidifying-side bypass line 21i. The refrigerant control valve 33 may include a first port 33a fluidly communicating with the interior condenser 32, a second port 33b fluidly communicating with the exterior heat exchanger 34, and the third port 33c fluidly communicating with the battery chiller 38 and the evaporator 36. The refrigerant control valve 33 may be configured to allow the first port 33a to communicate with at least one of the second port 33b and the third port 33c by an actuator 33d or to close all of the first port 33a, the second port 33b, and the third port 33c. For example, the refrigerant control valve 33 may be designed to move a valve member such as a ball member or a needle member in a valve housing to thereby allow the first port 33a to be fluidly connected to at least one of the second port 33b and the third port 33c or to close all of the first port 33a, the second port 33b, and the third port 33c. The valve member may be moved by the actuator 33d.

When the refrigerant control valve 33 performs a first switching operation to allow the first port 33a to be fluidly connected to the second port 33b, the refrigerant discharged from the interior condenser 32 may be directed to the exterior heat exchanger 34 through the first port 33a and the second port 33b. When the refrigerant control valve 33 performs the first switching operation, the opening degree of the second port 33b may be adjusted by the valve member so that the refrigerant may or may not be expanded. According to an embodiment, when the refrigerant control valve 33 performs the first switching operation, the opening degree of the second port 33b may be adjusted by the valve member to exceed 0% and be less than 100% so that the refrigerant discharged from the second port 33b of the refrigerant control valve 33 may be expanded. According to another embodiment, when the refrigerant control valve 33 performs the first switching operation, the opening degree of the second port 33b may be adjusted to 100% by the valve member (i.e., the second port 33b may be fully opened) so that the refrigerant discharged from the second port 33b of the refrigerant control valve 33 may not be expanded.

When the refrigerant control valve 33 performs a second switching operation to allow the first port 33a to be fluidly connected to the third port 33c, the refrigerant discharged from the interior condenser 32 may be directed to the refrigerant passage 38a of the battery chiller 38 and/or the evaporator 36 through the first port 33a and the third port 33c, thereby bypassing the exterior heat exchanger 34. When the refrigerant control valve 33 performs the second switching operation, the opening degree of the third port 33c may be adjusted to 100% by the valve member (i.e., the third port 33c may be fully opened) so that the refrigerant discharged from the third port 33c of the refrigerant control valve 33 may not be expanded.

When the refrigerant control valve 33 performs a third switching operation to close the first port 33a, the second port 33b, and the third port 33c, the refrigerant discharged from the interior condenser 32 may be directed to the third port 37c of the chiller-side expansion valve 37 through the heating-side bypass line 21h.

The exterior heat exchanger 34 may be disposed adjacent to a front grille of the vehicle, and the exterior heat exchanger 34 may be exposed to the ambient air so that heat may be transferred between the exterior heat exchanger 34 and the ambient air. The exterior heat exchanger 34 may be configured to condense the refrigerant received from the interior condenser 32. An active air flap (not shown) may be provided to open or close the front grille of the vehicle. In particular, the exterior heat exchanger 34 may exchange heat with the ambient air forcibly blown by a cooling fan (not shown) so that a heat transfer rate between the exterior heat exchanger 34 and the ambient air may be further increased. During a cooling operation of the HVAC subsystem 11, the exterior heat exchanger 34 may be configured to condense the refrigerant received from the interior condenser 32. In other words, the exterior heat exchanger 34 may serve as a condenser that condenses the refrigerant during the cooling operation of the HVAC subsystem 11. During a heating operation of the HVAC subsystem 11, the exterior heat exchanger 34 may serve as an evaporator that evaporates the refrigerant.

The cooling-side expansion valve 35 may be disposed between the exterior heat exchanger 34 and the evaporator 36 in the refrigerant circulation path 21. The cooling-side expansion valve 35 may be disposed on the upstream side of the evaporator 36 so that it may adjust the flow of the refrigerant and/or the flow rate of the refrigerant into the evaporator 36, and the cooling-side expansion valve 35 may be configured to expand the refrigerant received from the exterior heat exchanger 34. The cooling-side expansion valve 35 may be a thermal expansion valve (TXV) which senses the temperature and/or pressure of the refrigerant and adjusts the opening degree of the cooling-side expansion valve 35.

According to an embodiment of the present disclosure, the cooling-side expansion valve 35 may be a TXV having a shut-off valve selectively blocking or unblocking the flow of the refrigerant into an internal passage of the cooling-side expansion valve 35, and the shut-off valve may be a solenoid valve. As a controller 100 controls the shut-off valve, the shut-off valve may be opened or closed so that the shut-off valve may unblock or block the flow of the refrigerant into the cooling-side expansion valve 35. When the shut-off valve is opened, the refrigerant may be allowed to flow into the cooling-side expansion valve 35. Additionally, when the shut-off valve is closed, the refrigerant may be blocked from flowing into the cooling-side expansion valve 35. According to an embodiment, the shut-off valve may be mounted in a valve body of the cooling-side expansion valve 35, thereby opening or closing the internal passage of the cooling-side expansion valve 35. According to another embodiment, the shut-off valve may be disposed on the upstream side of the cooling-side expansion valve 35, thereby selectively opening or closing an inlet of the cooling-side expansion valve 35.

When the shut-off valve is closed, the cooling-side expansion valve 35 may be blocked. Accordingly, the refrigerant may not be directed to the cooling-side expansion valve 35 and the evaporator 36, but may only be directed to the battery chiller 38. In other words, when the shut-off valve is closed, the cooling operation of the HVAC subsystem 11 may not be performed. When the shut-off valve is opened, the refrigerant may be directed to the cooling-side expansion valve 35 and the evaporator 36. In other words, when the shut-off valve is opened, the cooling operation of the HVAC subsystem 11 may be performed.

The evaporator 36 may be configured to cool the air using the refrigerant expanded by the cooling-side expansion valve 35.

The battery chiller 38 may be fluidly connected to the distribution line 21g. The battery chiller 38 may be configured to transfer heat between the refrigerant passing through the distribution line 21g and a coolant passing through a coolant circulation path 23. The battery chiller 38 may include the refrigerant passage 38a through which the refrigerant passes, and a coolant passage 38b through which the coolant passes. The refrigerant passage 38a may be fluidly connected to the distribution line 21g, and the coolant passage 38b may be fluidly connected to the coolant circulation path 23. The refrigerant passage 38a and the coolant passage 38b may be adjacent to each other or contact each other in the battery chiller 38, and the refrigerant passage 38a may be fluidly separated from the coolant passage 38b. Accordingly, the battery chiller 38 may be configured to transfer heat between the coolant passing through the coolant passage 38b and the refrigerant passing through the refrigerant passage 38a. The refrigerant passage 38a of the battery chiller 38 may be located on the upstream side of the compressor 31. Accordingly, the refrigerant discharged from the refrigerant passage 38a of the battery chiller 38 may be directed to the compressor 31.

The chiller-side expansion valve 37 may be disposed on the upstream side of the refrigerant passage 38a of the battery chiller 38 on the distribution line 21g. The chiller-side expansion valve 37 may be configured to control the flow of the refrigerant in a manner that allows the refrigerant to flow from any one of the exterior heat exchanger 34 and the interior condenser 32 to the refrigerant passage 38a of the battery chiller 38. In particular, the chiller-side expansion valve 37 may adjust the flow of the refrigerant and/or the flow rate of the refrigerant into the refrigerant passage 38a of the battery chiller 38. Additionally, the chiller-side expansion valve 37 may expand the refrigerant received from the exterior heat exchanger 34 or the interior condenser 32.

The chiller-side expansion valve 37 may include a first port 37a fluidly communicating with the refrigerant passage 38a of the battery chiller 38, a second port 37b fluidly communicating with the exterior heat exchanger 34, and the third port 37c fluidly communicating with the heating-side bypass line 21h.

The chiller-side expansion valve 37 may be configured to allow the first port 37a to communicate with at least one of the second port 37b and the third port 37c by an actuator 37d. For example, the chiller-side expansion valve 37 may be designed to move a valve member such as a ball member or a needle member in a valve housing to thereby allow the first port 37a to be fluidly connected to at least one of the second port 37b and the third port 37c. The valve member may be moved by the actuator 37d.

When the chiller-side expansion valve 37 performs a first switching operation to allow the first port 37a to be fluidly connected to the second port 37b, the refrigerant discharged from the exterior heat exchanger 34 may be directed to the refrigerant passage 38a of the battery chiller 38 through the second port 37b and the first port 37a. When the chiller-side expansion valve 37 performs the first switching operation, the opening degree of the first port 37a may be adjusted by the valve member so that the refrigerant may be expanded. When the chiller-side expansion valve 37 performs the first switching operation, the opening degree of the first port 37a may be adjusted by the valve member to exceed 0% and be less than 100% so that the refrigerant discharged from the first port 37a of the chiller-side expansion valve 37 may be expanded.

When the chiller-side expansion valve 37 performs a second switching operation to allow the first port 37a to be fluidly connected to the third port 37c, the refrigerant discharged from the interior condenser 32 may be directed to the refrigerant passage 38a of the battery chiller 38 through the heating-side bypass line 21h and the third port 37c and the first port 37a of the chiller-side expansion valve 37. As a result, the refrigerant bypasses the exterior heat exchanger 34. When the chiller-side expansion valve 37 performs the second switching operation, the opening degree of the first port 37a may be adjusted by the valve member to exceed 0% and be less than 100% so that the refrigerant discharged from the first port 37a of the chiller-side expansion valve 37 may be expanded.

The HVAC subsystem 11 may further include the accumulator 39 disposed on the upstream side of the compressor 31 in the refrigerant circulation path 21. The accumulator 39 may be configured to separate a liquid refrigerant from the refrigerant received from the refrigerant passage 38a of the battery chiller 38 and/or the evaporator 36, thereby preventing the liquid refrigerant from flowing into the compressor 31.

According to an embodiment of the present disclosure, the accumulator 39 may include a refrigerant passage 39a through which the refrigerant passes, and a coolant passage 39b through which the coolant passes. The refrigerant passage 39a may be fluidly connected to the sixth refrigerant line 21f of the refrigerant circulation path 21, and the coolant passage 39b may be fluidly connected to the coolant circulation path 23 of the coolant subsystem 12. The accumulator 39 may serve as a heat exchanger that transfers heat between the coolant passing through the coolant passage 39b and the refrigerant passing through the refrigerant passage 39a.

The refrigerant passage 38a of the battery chiller 38 may be located on the upstream side of the refrigerant passage 39a of the accumulator 39. Accordingly, the refrigerant discharged from the refrigerant passage 38a of the battery chiller 38 may be directed to the refrigerant passage 39a of the accumulator 39. The coolant passage 38b of the battery chiller 38 may be located on the downstream side of the coolant passage 39b of the accumulator 39. Accordingly, the coolant discharged from the coolant passage 39b of the accumulator 39 may be directed to the coolant passage 38b of the battery chiller 38.

As described above, the refrigerant circulation path 21 of the HVAC subsystem 11 may be fluidly connected to the refrigerant passage 38a of the battery chiller 38 and the refrigerant passage 39a of the accumulator 39 so that the refrigerant may sequentially pass through the refrigerant passage 38a of the battery chiller 38 and the refrigerant passage 39a of the accumulator 39 and then be directed to the compressor 31.

The coolant subsystem 12 may include the coolant circulation path 23 through which the coolant circulates. The coolant circulation path 23 may be fluidly connected to the battery 41, the PE component 42, a coolant heater 43, a reservoir 44, a coolant control valve 50, a radiator 45, the coolant passage 39b of the accumulator 39, and the coolant passage 38b of the battery chiller 38.

The coolant circulation path 23 may allow the flow of the coolant to vary depending on an operating mode (a heating mode, a cooling mode, a dehumidifying mode, and the like) of the HVAC subsystem 11, a cooling mode and a warming-up mode of the battery 41, a cooling mode of the PE component 42, and the like.

According to an embodiment, the coolant circulation path 23 may include a first coolant line 23a extending from a first port 51 of the coolant control valve 50 to the coolant passage 39b of the accumulator 39, a second coolant line 23b extending from the coolant passage 39b of the accumulator 39 to the coolant passage 38b of the battery chiller 38, and a third coolant line 23c extending from the coolant passage 38b of the battery chiller 38 to a second port 52 of the coolant control valve 50. The coolant circulation path 23 may also include a fourth coolant line 23d extending from the coolant passage 38b of the battery chiller 38 to the radiator 45, a fifth coolant line 23e extending from the radiator 45 to a third port 53 of the coolant control valve 50, and a sixth coolant line 23f extending from a fourth port 54 of the coolant control valve 50 to a joint point 24a of the first coolant line 23a. Additionally, the coolant circulation path 23 may also include a seventh coolant line 23h extending from a fifth port 55 of the coolant control valve 50 to a joint point 24c of the fourth coolant line 23d, and a battery bypass line 23g extending from an upstream point of the battery 41 to a downstream point 24b of the battery 41 on the sixth coolant line 23f.

The battery 41 may have a coolant passage provided inside or outside thereof. As the coolant passes through the coolant passage of the battery 41, the coolant may be heated or cooled, and the battery 41 may be maintained at an appropriate temperature. For example, the battery 41 may be a high-voltage battery pack of an electric vehicle. The battery 41 may be disposed on the sixth coolant line 23f.

The PE component 42 may have a coolant passage provided inside or outside thereof. As the coolant passes through the coolant passage of the PE component 42, the coolant may be heated or cooled, and the PE component 42 may be maintained at an appropriate temperature. For example, the PE component 42 may be an electric motor which is a driving source of an electric vehicle, an inverter, and the like. The PE component 42 may be disposed on the seventh coolant line 23h.

The coolant heater 43 may have a coolant passage provided inside or outside thereof, and the coolant heater 43 may be an electric heater that heats the coolant. The coolant heater 43 may be disposed on the sixth coolant line 23f, and the coolant heater 43 may be disposed on the downstream side of the battery 41. The coolant heater 43 may be located on the upstream side of the coolant passage 39b of the accumulator 39, and the coolant heated by the coolant heater 43 may sequentially pass through the coolant passage 39b of the accumulator 39 and the coolant passage 38b of the battery chiller 38.

The radiator 45 may be disposed adjacent to the front grille of the vehicle, and the radiator 45 may have a coolant passage provided therein. The coolant passing through the coolant passage of the radiator 45 may be cooled by the ambient air passing by an exterior surface of the radiator 45. The radiator may cool the coolant using the ambient air forcibly blown by a cooling fan (not shown). The reservoir 44 and the radiator 45 may be disposed on the fifth coolant line 23e, and the reservoir 44 may be disposed on the downstream side of the radiator 45.

The coolant control valve 50 may be configured to control the flow of the coolant passing through the coolant passage 39b of the accumulator 39, the coolant passage 38b of the battery chiller 38, the battery 41, the PE component 42, the coolant heater 43, and the radiator 45. According to an embodiment, the coolant control valve 50 may include the first port 51 fluidly communicating with the coolant passage 39b of the accumulator 39, the second port 52 fluidly communicating with the coolant passage 38b of the battery chiller 38, the third port 53 fluidly communicating with the radiator 45, the fourth port 54 fluidly communicating with the battery 41, and the fifth port 55 fluidly communicating with the PE component 42. The coolant control valve 50 may be configured to operate in various switching modes to allow the first port 51, the second port 52, the third port 53, the fourth port 54, and the fifth port 55 to be fluidly connected to each other.

The coolant subsystem 12 may include a first pump 47 fluidly communicating with the fourth port 54 of the coolant control valve 50. The first pump 47 may be disposed on the sixth coolant line 23f, and the first pump 47 may be disposed on the upstream side of the battery 41.

The coolant subsystem 12 may include a second pump 48 fluidly communicating with the fifth port 55 of the coolant control valve 50. The second pump 48 may be disposed on the seventh coolant line 23h, and the second pump 48 may be disposed on the upstream side of the PE component 42.

The coolant subsystem 12 may include a distribution valve 46 configured to control the flow of the coolant in a manner that allows the coolant discharged from the fourth port 54 of the coolant control valve 50 to be directed to at least one of the battery 41 and the battery bypass line 23g. The distribution valve 46 may be disposed at a connection point of the battery bypass line 23g and the sixth coolant line 23f. In other words, the distribution valve 46 may be located at a point at which the coolant is distributed to the battery 41 and the battery bypass line 23g. According to an embodiment, the distribution valve 46 may include an inlet port 46a fluidly communicating with the fourth port 54 of the coolant control valve 50, a first outlet port 46b fluidly communicating with the battery 41, and a second outlet port 46c fluidly communicating with the battery bypass line 23g.

The distribution valve 46 may be configured to allow the inlet port 46a to be fluidly connected to at least one of the first outlet port 46b and the second outlet port 46c by an actuator 46d. For example, the distribution valve 46 may be designed to move a valve member such as a ball member or a needle member in a valve housing to thereby allow the inlet port 46a to communicate with at least one of the first outlet port 46b and the second outlet port 46c. The valve member may be moved by the actuator 46d.

When the distribution valve 46 performs a first switching operation to allow the inlet port 46a to be fluidly connected to the first outlet port 46b, the coolant discharged from the fourth port 54 of the coolant control valve 50 may be directed to the coolant passage of the battery 41 through the inlet port 46a and the first outlet port 46b.

When the distribution valve 46 performs a second switching operation to allow the inlet port 46a to be fluidly connected to the second outlet port 46c, the coolant discharged from the fourth port 54 of the coolant control valve 50 may be directed to the battery bypass line 23g through the inlet port 46a and the second outlet port 46c.

The controller 100 may be configured to control the operations of the compressor 31, the actuator 33d of the refrigerant control valve 33, the actuator 37d of the chiller-side expansion valve 37, the coolant control valve 50, the first pump 47, the second pump 48, the actuator 46d of the distribution valve 46, and the like depending on an operating mode (a heating mode, a cooling mode, a dehumidifying mode, and the like) of the HVAC subsystem 11, a cooling mode and a warming-up mode of the battery 41, a cooling mode of the PE component 42, and the like.

As described above, the coolant circulation path 23 may be fluidly connected to the coolant heater 43, the coolant passage 39b of the accumulator 39, and the coolant passage 38b of the battery chiller 38. As a result, the coolant heated by the coolant heater 43 may sequentially pass through the coolant passage 39b of the accumulator 39 and the coolant passage 38b of the battery chiller 38. Accordingly, the heated coolant may release heat to the refrigerant passing through the refrigerant passage 39a of the accumulator 39 and the refrigerant passing through the refrigerant passage 38a of the battery chiller 38. Thus, the refrigerant may absorb heat in two steps by the battery chiller 38 and the accumulator 39 so that heat absorption and evaporation of the refrigerant may be significantly improved.

FIG. 1 illustrates a process of a vehicle thermal management system according to an embodiment of the present disclosure in which a refrigerant absorbs heat through an accumulator and a battery chiller.

Referring to FIG. 1, in a condition in which an ambient temperature is relatively low (i.e., in winter, in a cold area, and the like), the HVAC subsystem 11 may operate in a heating mode. The refrigerant control valve 33 may perform the third switching operation to close all of the first port 33a, the second port 33b, and the third port 33c. The chiller-side expansion valve 37 may perform the second switching operation to allow the first port 37a to be fluidly connected to the third port 37c. The cooling-side expansion valve 35 may be blocked. The refrigerant compressed by the compressor 31 may pass through the interior condenser 32 and the refrigerant discharged from the interior condenser 32 may pass through the third port 37c and the first port 37a of the chiller-side expansion valve 37 through the heating-side bypass line 21h. The refrigerant passing through the first port 37a of the chiller-side expansion valve 37 may be expanded and the expanded refrigerant may pass through the refrigerant passage 38a of the battery chiller 38. The refrigerant discharged from the refrigerant passage 38a of the battery chiller 38 may pass through the refrigerant passage 39a of the accumulator 39 and the refrigerant discharged from the refrigerant passage 39a of the accumulator 39 may flow into the compressor 31.

Referring to FIG. 1, the coolant control valve 50 may operate to allow the second port 52 to be fluidly connected to the fourth port 54. The distribution valve 46 may perform the second switching operation to allow the inlet port 46a to be fluidly connected to the second outlet port 46c. The coolant may be directed to the coolant heater 43 through the inlet port 46a, the second outlet port 46c of the distribution valve 46, and the battery bypass line 23g by the first pump 47. As the coolant heater 43 operates, the coolant may be heated by the coolant heater 43, and the heated coolant may pass through the coolant passage 39b of the accumulator 39. The coolant discharged from the coolant passage 39b of the accumulator 39 may pass through the coolant passage 38b of the battery chiller 38. The coolant discharged from the coolant passage 38b of the battery chiller 38 may be directed to the second port 52 of the coolant control valve 50.

As described above, the coolant heated by the coolant heater 43 may sequentially pass through the coolant passage 39b of the accumulator 39 and the coolant passage 38b of the battery chiller 38. Accordingly, the heated coolant may release heat to the refrigerant passing through the refrigerant passage 39a of the accumulator 39 and the refrigerant passing through the refrigerant passage 38a of the battery chiller 38. Thus, the refrigerant may absorb heat from the coolant in two steps through the battery chiller 38 and the accumulator 39. As a result, the heat absorption and evaporation of the refrigerant may be significantly improved, and cabin heating performance of the HVAC subsystem 11 may be significantly improved in a condition in which the ambient temperature is relatively low.

FIG. 2 illustrates a process of a vehicle thermal management system according to an embodiment of the present disclosure in which a refrigerant absorbs heat through an accumulator, a battery chiller, and an exterior heat exchanger.

Referring to FIG. 2, in a condition in which an ambient temperature is relatively low (i.e., in winter, in a cold area, and the like), the HVAC subsystem 11 may operate in a heating mode. The refrigerant control valve 33 may perform the first switching operation to allow first port 33a to be fluidly connected to the second port 33b. The chiller-side expansion valve 37 may perform the first switching operation to allow the first port 37a to be fluidly connected to the second port 37b. The cooling-side expansion valve 35 may be blocked. The refrigerant compressed by the compressor 31 may pass through the interior condenser 32, and the refrigerant discharged from the interior condenser 32 may pass through the first port 33a and the second port 33b of the refrigerant control valve 33. When the refrigerant control valve 33 performs the first switching operation, the opening degree of the second port 33b may be adjusted by the valve member to exceed 0% and be less than 100% so that the refrigerant discharged from the second port 33b of the refrigerant control valve 33 may be expanded. The refrigerant discharged from the second port 33b of the refrigerant control valve 33 may pass through the exterior heat exchanger 34 through the third refrigerant line 21c. The refrigerant passing through the exterior heat exchanger 34 may absorb heat from the ambient air. The refrigerant discharged from the exterior heat exchanger 34 may pass through the second port 37b and the first port 37a of the chiller-side expansion valve 37. The refrigerant passing through the first port 37a of the chiller-side expansion valve 37 may be expanded, and the expanded refrigerant may pass through the refrigerant passage 38a of the battery chiller 38. The refrigerant discharged from the refrigerant passage 38a of the battery chiller 38 may pass through the refrigerant passage 39a of the accumulator 39, and the refrigerant discharged from the refrigerant passage 39a of the accumulator 39 may flow into the compressor 31.

Referring to FIG. 2, the coolant control valve 50 of the coolant subsystem 12 may operate to allow the second port 52 to be fluidly connected to the fourth port 54. The distribution valve 46 may perform the second switching operation to allow the inlet port 46a to be fluidly connected to the second outlet port 46c. The coolant may be directed to the coolant heater 43 through the inlet port 46a, the second outlet port 46c of the distribution valve 46, and the battery bypass line 23g by the first pump 47. As the coolant heater 43 operates, the coolant may be heated by the coolant heater 43, and the heated coolant may pass through the coolant passage 39b of the accumulator 39. The coolant discharged from the coolant passage 39b of the accumulator 39 may pass through the coolant passage 38b of the battery chiller 38, and the coolant discharged from the coolant passage 38b of the battery chiller 38 may be directed to the second port 52 of the coolant control valve 50.

As described above, the coolant heated by the coolant heater 43 may sequentially pass through the coolant passage 39b of the accumulator 39 and the coolant passage 38b of the battery chiller 38. Accordingly, the heated coolant may release heat to the refrigerant passing through the refrigerant passage 39a of the accumulator 39 and the refrigerant passing through the refrigerant passage 38a of the battery chiller 38. In addition, the refrigerant may absorb heat from the ambient air in the exterior heat exchanger 34. Thus, the refrigerant may absorb heat from the coolant in two steps through the battery chiller 38 and the accumulator 39 and the refrigerant may absorb heat from the ambient air through the exterior heat exchanger 34. As a result, heat absorption and evaporation of the refrigerant may be significantly improved, and cabin heating performance of the HVAC subsystem 11 may be significantly improved in a condition in which the ambient temperature is relatively low.

As set forth above, the vehicle thermal management system according to the embodiments of the present disclosure may be designed to improve heating performance by transferring heat of the coolant heater to the accumulator in a condition in which the ambient temperature is relatively low (i.e., in winter, in a cold area, and the like).

According to embodiments of the present disclosure, the coolant circulation path may be fluidly connected to the coolant heater, the coolant passage of the accumulator, and the coolant passage of the battery chiller so that the coolant heated by the coolant heater may sequentially pass through the coolant passage of the accumulator and the coolant passage of the battery chiller. Accordingly, the heated coolant may release heat to the refrigerant passing through the refrigerant passage of the accumulator and the refrigerant passing through the refrigerant passage of the battery chiller. Thus, the refrigerant may absorb heat from the coolant in two steps through the battery chiller and the accumulator so that the heat absorption and evaporation of the refrigerant may be significantly improved.

Although the present disclosure has been described with reference to the embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A vehicle thermal management system, comprising:
a heating, ventilation, and air conditioning (HVAC) subsystem including a compressor, an accumulator disposed on an upstream side of the compressor, and a refrigerant circulation path fluidly connected to the accumulator; and
a coolant subsystem including a coolant heater and a coolant circulation path fluidly connected to the coolant heater,
wherein the accumulator includes a refrigerant passage fluidly connected to the refrigerant circulation path and includes a coolant passage fluidly connected to the coolant circulation path.

2. The vehicle thermal management system according to claim 1, wherein the coolant heater is located on an upstream side of the coolant passage of the accumulator.

3. The vehicle thermal management system according to claim 1, further comprising a battery chiller including a refrigerant passage fluidly connected to the refrigerant circulation path and including a coolant passage fluidly connected to the coolant circulation path.

4. The vehicle thermal management system according to claim 3, wherein the refrigerant passage of the battery chiller is located on an upstream side of the refrigerant passage of the accumulator, and wherein the coolant passage of the battery chiller is located on a downstream side of the coolant passage of the accumulator.

5. The vehicle thermal management system according to claim 3, wherein:
the HVAC subsystem further includes an interior condenser disposed on a downstream side of the compressor, a refrigerant control valve disposed on a downstream side of the interior condenser, an exterior heat exchanger disposed on a downstream side of the refrigerant control valve, and a chiller-side expansion valve disposed on the upstream side of the refrigerant passage of the battery chiller, and
the chiller-side expansion valve is configured to allow a refrigerant to flow from any one of the exterior heat exchanger and the interior condenser to the refrigerant passage of the battery chiller.

6. The vehicle thermal management system according to claim 5, wherein the refrigerant circulation path includes a heating-side bypass line extending from an upstream point of the refrigerant control valve to an upstream point of the refrigerant passage of the battery chiller.

7. The vehicle thermal management system according to claim 6, wherein the chiller-side expansion valve includes a first port fluidly communicating with the refrigerant passage of the battery chiller, a second port fluidly communicating with the exterior heat exchanger, and a third port fluidly communicating with the heating-side bypass line.

8. The vehicle thermal management system according to claim 7, wherein the chiller-side expansion valve is configured to allow the first port to be fluidly connected to at least one of the second port and the third port by an actuator.

9. The vehicle thermal management system according to claim 3, wherein the coolant subsystem further includes a battery and a coolant control valve fluidly connected to the coolant circulation path, and wherein the coolant control valve is configured to control a flow of a coolant passing through the battery, the coolant heater, the coolant passage of the accumulator, and the coolant passage of the battery chiller.

10. The vehicle thermal management system according to claim 9, wherein the coolant heater is located on a downstream side of the battery.

11. The vehicle thermal management system according to claim 10, wherein the coolant subsystem further includes a battery bypass line extending from an upstream point of the battery to a downstream point of the battery.

12. The vehicle thermal management system according to claim 11, wherein the coolant subsystem further includes a distribution valve configured to allow the coolant discharged from the coolant control valve to be directed to at least one of the battery and the battery bypass line.

13. The vehicle thermal management system according to claim 12, wherein the distribution valve includes an inlet port fluidly communicating with the coolant control valve, a first outlet port fluidly communicating with the battery, and a second outlet port fluidly communicating with the battery bypass line.
